(19) United States
(12) Patent Application Publication
(10) Pub. No.: US 2008/0196303 A1
(43) Pub. Date: Aug. 21, 2008

(54) Drip Irrigation System

(76) Inventor: Min Song Kim, Seoul (KR)

Correspondence Address: ROTHWELL, FIGG, ERNST & MANBECK, P.C., 1425 K STREET, N.W., SUITE 800, WASHINGTON, DC, 20005, US

(21) Appl. No.: 11/813,554

(22) PCT Filed: Nov. 22, 2005
(86) PCT No.: PCT/KR2005/003955

§ 371 Date: Jul. 9, 2007

(30) Foreign Application Priority Data
Feb. 24, 2005 (KR) 10-2005-0015222
Jun. 17, 2005 (KR) 10-2005-0052187

(51) Int. Cl. A01G 25/02

(52) U.S. Cl. 47/48.5

(57) ABSTRACT

Most mushroom farmhouses employ surface irrigation for watering, which causes brown spot on mushroom, making the mushroom die or get brown, so cultivated mycelia become broken, preventing continued mushroom farming. In a drip irrigation system, water is flowed through any or both ends of the rubber outer tube (7a), 11a doubly inserted into blade scar of the dripping nozzle (11) or hose (7) only during water dripping, and the rubber outer tube (7a), 11a prevents direct exposure of blade scar to the culture medium layer, not contacting water with external oxygen, thereby preventing mycelia from being coated in the blade scar to clog water hole. Various alien substances are not introduced through the blade scars 6 formed in the flexible soft rubber, and insect control liquid and water is ejected without any clogging by water pressure to ensure effective dripping of water, nutrition liquid and insect control liquid to the culture medium layer of a mushroom cultivating plate.

The present invention relates to a drip irrigation system, and more particularly to a drip irrigation system capable of dripping water, nutrition liquid or insect control liquid to a culture medium layer or soil of a mushroom cultivating plate or port of a mushroom farm.

### BACKGROUND ART

Generally, a mushroom cultivating farmhouse has difficulties in watering work that requires a heavy labor.

Success and failure of the mushroom farming is depending on keeping suitable temperature, humidity and ventilation, and the watering work is most essential among them, and unsuitable watering will give a serious influence on the yield.

In most mushroom farmhouses, the watering work employs surface irrigation, so moisture gives an influence on mushroom mustard, which prevents oxygen respiration of the mushroom. It causes brown spot on mushroom, which makes the mushroom die or get brown, so cultivated mycelia become broken and thus the mushroom farming cannot be continued.

In order to solve the above problem, a water injection nozzle for mushroom culture medium in which a plurality of spray holes are formed in an injection tube coupled to a high pressure tube was disclosed in Korean Utility Model Registration No. 0196082 as a prior art. However, if the spray holes of the injection tube inserted into the culture medium layer are clogged by alien substances of the culture medium layer or alien substances mixed in various nutrition liquids or insect control liquid, it is impossible to expect a desired dripping effect.

In addition, Korean Patent Publication No. 10-2004-0067099 discloses ‘multi-purpose irrigation device for cultivating plants’, in which discharge tubes curved downward are formed on an upper surface of an installed synthetic resin at regular intervals, and a cork having a filtering net is covered on each discharge hole. It is generally used for farming vegetables or flowers.

As mentioned above, this irrigation device should supply water below the downwardly curved discharge tubes that are protruded to a predetermined height, so it should irrigate the culture medium layer in a mushroom cultivating plate or port limitedly and not suitable as an irrigation device for mushroom cultivating farmhouses. In addition, since the discharge tubes are diverged on the main pipe as mentioned above, an installation cost of farmhouse is increased.

In addition, the dripping hose of the conventional dripping farming device has fine holes, the holes are frequently clogged, and a water pressure is seriously changed depending on height of the dripping hose caused by topography. Moreover, since the holes of the dripping hose are directly exposed from the hose surface, plant roots are frequently penetrated therein to clog the holes of the dripping hose.

### DISCLOSURE OF INVENTION

### Technical Problem

The present invention is designed in consideration of the above problems, and therefore it is an object of the invention to provide a drip irrigation system for irrigating a culture medium layer in a dripping manner in order to prevent brown spot without using surface irrigation that supplies water on mycelia, thereby supplying various nutrition liquid and insect control liquid together with water.

In particular, an object of the present invention is to provide a useful drip irrigation system that may be economically installed at a farming spot with easiness suitably for a cultivating environment of each farmhouse and also nozzle holes are not clogged by alien substances.

### Technical Solution

In order to accomplish the above object, the present invention provides a drip irrigation system used in a mushroom cultivating equipment in which a high pressure tube of a predetermined length is inserted into a culture medium layer of a mushroom cultivating plate placed on a frame so that water in a water tank having a ball tap is continuously supplied, wherein a dripping hose made of soft rubber with a pre-determined length and having several blade scars with a length of 1 to 2 mm formed only on a middle outer circumference thereof is provided in every predetermined region of the high pressure tube so that an outer tube made of soft rubber is inserted into the dripping hose to cover only the blade scars and both ends of the dripping hose are inserted into the high pressure tube and fixed by a tie band, wherein, wherein an outer tube made of soft rubber is inserted into a dripping nozzle made of soft rubber with one sharp end and having several blade scars with a length of 1 to 2 mm formed only on a middle outer circumference thereof at the outermost end of the high pressure tube so as to cover the blade scars so that the outer tube is fixed to the high pressure tube by means of the tie band integrally with the dripping nozzle.

In the present invention, the dripping nozzle made of soft rubber is fixed to the high pressure tube by the tie band by inserting the outer tube made of soft rubber thereto so that the dripping nozzle is inserted into the culture medium of a mushroom cultivating port.

In the present invention, a step is formed in every predetermined region of the high pressure tube, at least one hole is formed at the center of the stepped dripping hose, and the outer tube made of soft rubber has a dripping ring having good flexibility so as to cover the step.

In the present invention, the dripping hose includes a high pressure tube having water possessing spaces provided at regular intervals with various shapes, and holes formed therein so that water or nutrition liquid is soaked therein; a dripping plate having fixed protrusions fixed to dripping plate fixing grooves so as to cover the water possessing spaces and the holes; and a dripping plate cover to which a dripping plate with an arch or other shape is detachably attached and including dripping cover fixing units fixed to cover fixing grooves of the high pressure tube so as to prevent a water flowing dripping portion of the holes or the water possessing spaces of the dripping plate from being completely clogged due to pressure of the culture medium layer or soil.

In the present invention, around the hole has a circumference concavely engraved so as to ensure water possessing spaces.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 shows an installed state of a drip irrigation system according to the present invention;

FIG. 2 is an enlarged perspective view showing a dripping hose corresponding to an A portion of FIG. 1;

FIG. 3 is an enlarged perspective view showing a dripping nozzle corresponding to a B portion of FIG. 2;

FIG. 4 shows a modification of the present invention in which a dripping hose is installed to a predetermined region of a high pressure pipe inserted into a culture medium layer of a mushroom cultivating plate, and a dripping nozzle is installed to its end;

FIG. 5 shows a dripping nozzle inserted into a culture medium layer of a mushroom cultivating port according to another embodiment of the present invention;

FIG. 6 shows a dripping hose in which an outer tube made of soft rubber is inserted by forming a step in a predetermined region of a high pressure tube inserted into a culture medium layer of a mushroom cultivating plate;

FIG. 7 shows that water is ejected at both ends of a dripping ring made of soft rubber inserted into the dripping hose of FIG. 6;

FIG. 8 shows a dripping hose to which a dripping ring made of soft rubber is inserted by forming a step in a predetermined region of a high pressure tube and forming a waved water possessing space around a hole in the step;

FIG. 9 shows a dripping hose to which a dripping ring made of soft rubber is inserted by forming a step in a predetermined region of a high pressure tube and forming concave water possessing spaces with circular and rectangular shapes around a hole in the step;

FIG. 10 shows a dripping hose to which a dripping ring made of soft rubber is inserted by forming a step in a predetermined region of a high pressure tube and forming “−” and “+” holes in the step together with forming concave water possessing spaces with circular and rectangular shapes around the hole;

FIG. 11 is a cross sectional view showing a dripping hose buried in a heavy culture medium layer or under ground, wherein various water possessing spaces are formed around a hole, and wherein a dripping plate cover is inserted to the dripping plate so that a dripping plate made of silicon or soft rubber is inserted therein to cover the water possessing space, wherein water, nutritious liquid and insect controller liquid are soaked from holes;

FIG. 12 is a sectional view showing the dripping hose of FIG. 11, taken along the line A-A; and

FIG. 13 is an exploded perspective view showing a dripping hose to which the dripping plate cover of FIG. 11 is mounted.

### BEST MODE FOR CARRYING OUT THE INVENTION

Hereinafter, preferred embodiments of the present invention will be described in detail with reference to the accompanying drawings.

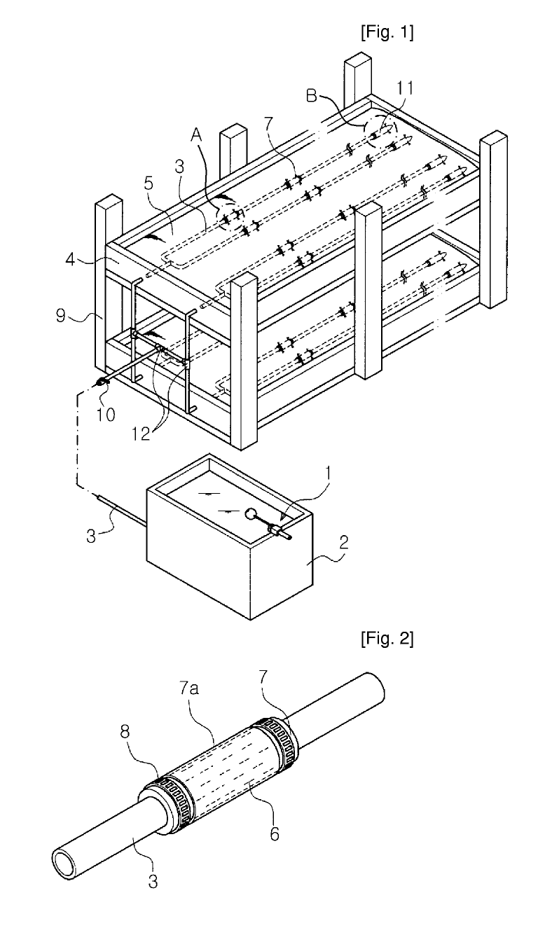

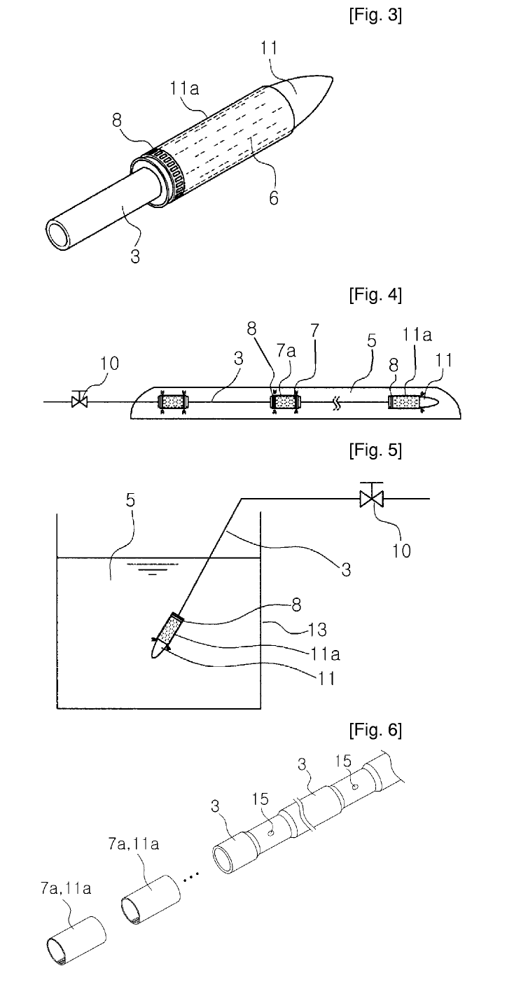

FIG. 1 shows an installed state of a drip irrigation system according to the present invention, FIG. 2 is an enlarged perspective view showing the dripping hose of an A portion of FIG. 1, and FIG. 3 is an enlarged perspective view showing a dripping nozzle of a B portion of FIG. 1. As shown in FIGS. 1 to 3, the drip irrigation system is used in a mushroom cultivating equipment in which a high pressure tube 3 of a pre-determined length is inserted into a culture medium layer 5 of a mushroom cultivating plate 4 placed on a frame 9 so that water in a water tank 2 having a ball tap 1 is continuously supplied, wherein a dripping hose 7 made of soft rubber with a pre-determined length and having several blade scars 6 with a length of 1 to 2 mm formed only on a middle outer circumference thereof is provided in every predetermined region of the high pressure tube 3 so that an outer tube 7a made of soft rubber is inserted into the dripping hose 7 to cover only the blade scars and both ends of the dripping hose 7 are inserted into the high pressure tube 3 and fixed by a tie band 8, wherein, wherein an outer tube 11a made of soft rubber is inserted into a dripping nozzle 11 made of soft rubber with one sharp end and having several blade scars 6 with a length of 1 to 2 mm formed only on a middle outer circumference thereof at the outermost end of the high pressure tube 3 so as to cover the blade scars so that the outer tube 11a is fixed to the high pressure tube 3 by means of the tie band 8 integrally with the dripping nozzle 11.

In the drawings, reference numeral 10 denotes a high pressure tube valve, 12 denotes a T tube installed to each diverged tube of the high pressure tube, and 13 denotes a mushroom cultivating port.

For reference, the water tank 2 installed in the present invention irrigates water to the culture medium layer using an atmospheric pressure manner, but it should be understood that a carrier means such as a motor pump (not shown) may be mounted to the water tank 2 in consideration of amount and distance of the mushroom cultivating port.

In the present invention configured as above, the dripping hose 7 is installed to a predetermined region of the high pressure tube 3 inserted into the culture medium layer 5 of the mushroom cultivating plate 4, and the dripping nozzle 11 is installed to an end of the high pressure tube 3, as shown in FIG. 4. Thus, water supplied from the water tank 2 flows through the several blade scars 6 formed respectively in the dripping nozzle and the dripping hose inserted into the culture medium layer through the high pressure tube, and then the water is soaked only through both ends of the soft rubber outer tube 7a inserted out of the dripping hose 7 or one end of the soft rubber outer tube 11a inserted into a blade scar of the dripping nozzle 11. Thus, it is possible to continuously supply water, nutrition liquid or insect control liquid to the culture medium layer 5.

In the above, the rubber outer tubes 7a, 11a are doubly inserted into each blade scar of the dripping hose 7 or the dripping nozzle 11 respectively in order to prevent a gap of the blade scar from being directly exposed to the culture medium layer. Thus, it is prevented that mycelia are coated in the blade scar holes due to contact with oxygen existing in the culture medium layer 5 and thus clog the hole. Only when water is dripped through the high pressure tube 3, water is dripped through both ends or one end of the rubber outer tubes 7a, 11a, and external air is isolated.

Meanwhile, as another embodiment of the present invention, the dripping nozzle is inserted into the culture medium layer 5 of the mushroom cultivating port 13, as shown in FIG. 5. In this case, an outer tube 11a made of soft rubber is inserted into the dripping nozzle 11 made of soft rubber which has several blade scars 6 with a length of 1 to 2 mm formed only on its middle outer circumference and also a sharp end in one side, thereby covering the blade scars port of the dripping nozzle 11. The soft rubber outer tube 11a allows water, nutrition liquid and insect control liquid to be continuously supplied to the culture medium layer 5 through the high pressure tube 3 fixed by a tie band 8 integrally with the dripping nozzle 11.

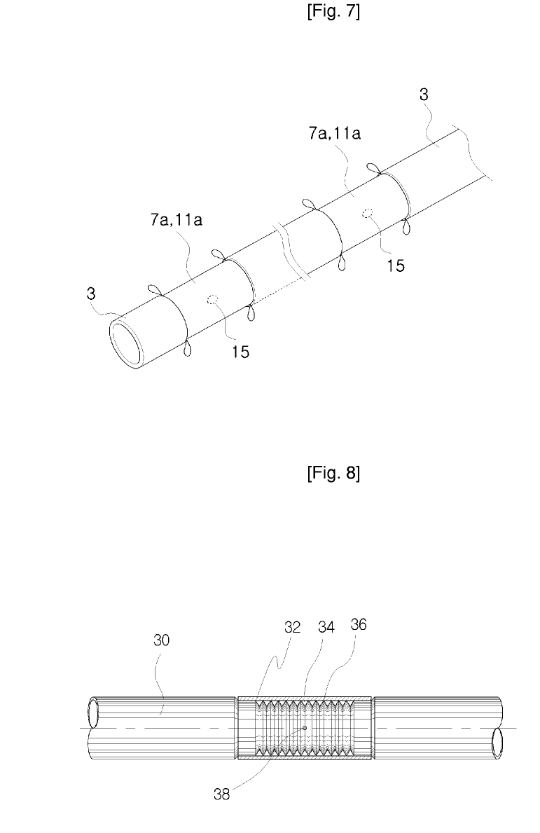

In addition, differently from the dripping hose 7 shown in FIGS. 1 and 2, FIGS. 6 and 7 show that a step is formed in every region of the dripping hose 7, at least one hole 15 is formed at the center of the stepped dripping hose 7, and a dripping ring 11a made of soft rubber is inserted thereto so as to cover the step portion completely or to cover only the hole 15. As shown in FIGS. 6 and 7, at least one hole 15 is formed at the center of the step without forming a blade scar or tie band 8 in the dripping hose 7, so water is soaked through both ends of the soft dripping ring 7a with good flexibility to continuously supply water, nutrition liquid and insect control liquid to the culture medium layer 5.

In this embodiment, the hole 15 is shown as a tiny hole as an example for easy understanding, but it may be changed into various shapes, not limited thereto. For example, holes 42, 44 having various shapes such as shape or + shape as shown in FIG. 10 may be formed, and a circumference of the hole may be engraved to form water possessing spaces 39, 40.

Hereinafter, another embodiment of the present invention will be described.

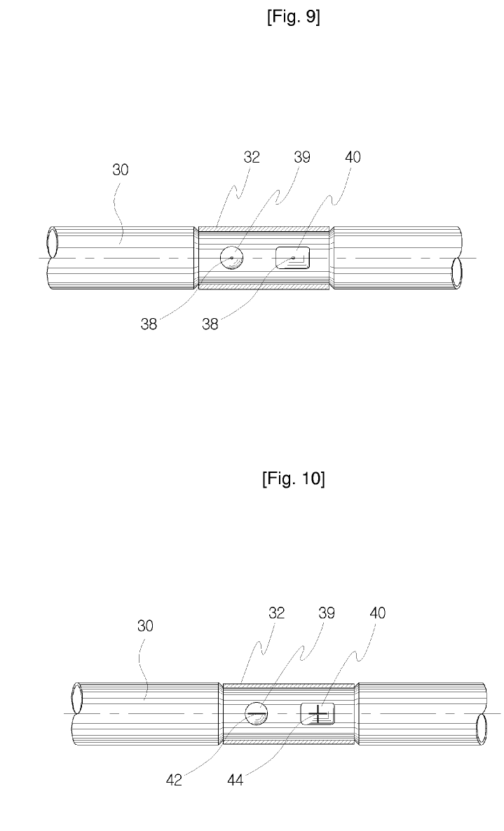

FIG. 8 shows a dripping hose to which a dripping ring made of soft rubber having good flexibility is inserted by forming a step in a predetermined region of a high pressure tube and forming a waved water possessing space around a hole in the step, FIG. 9 shows a dripping hose to which a dripping ring made of soft rubber is inserted by forming a step in a predetermined region of a high pressure tube and forming concave water possessing spaces with circular and rectangular shapes around a hole in the step, and FIG. 10 shows a dripping hose to which a dripping ring made of soft rubber having good flexibility is inserted by forming a step in a predetermined region of a high pressure tube and forming “−” and “+” holes in the step portion together with forming concave water possessing spaces with circular and rectangular shapes around the step.

In this embodiment, as shown in FIGS. 8 to 10, a tiny hole 38, a “−” shaped hole 42 or a “+” shaped hole 44 is formed at a suitable position in the step formed in every pre-determined region of the high pressure tube 30, and water possessing spaces 34, 39, 40 having various shapes are provided around the hole so that water may be constantly discharged without any pressure change of water flowing. A dripping ring 32 with good flexibility allows water to flow according to its expansion caused by water pressure. Thus, since a tiny hole is formed in the dripping hose to supply water, it may solve a hole-clogging problem, which often happened in a hole of a conventional dripping hose. That is to say, the dripping hose of the present invention forms a greater hole than a conventional one so as to eliminate the hole-clogging phenomenon and it may also decrease variation of water pressure caused by height of the dripping hose due to topography or position of the drip irrigation system. In addition, since the dripping ring 32 has good flexibility to allow supply of water or nutrition liquid, water may be easily dripped under ground, and also it prevents plant roots from penetrating into the hole, differently from the conventional one.

In the above drawings, the arrangement of the holes and the water possessing spaces is just an example for illustration only, and those having ordinary skill in the art will understand that there may be many modifications. For example, one hole or one water possessing space may be sufficient, or the above holes or water possessing spaces may be selectively arranged.

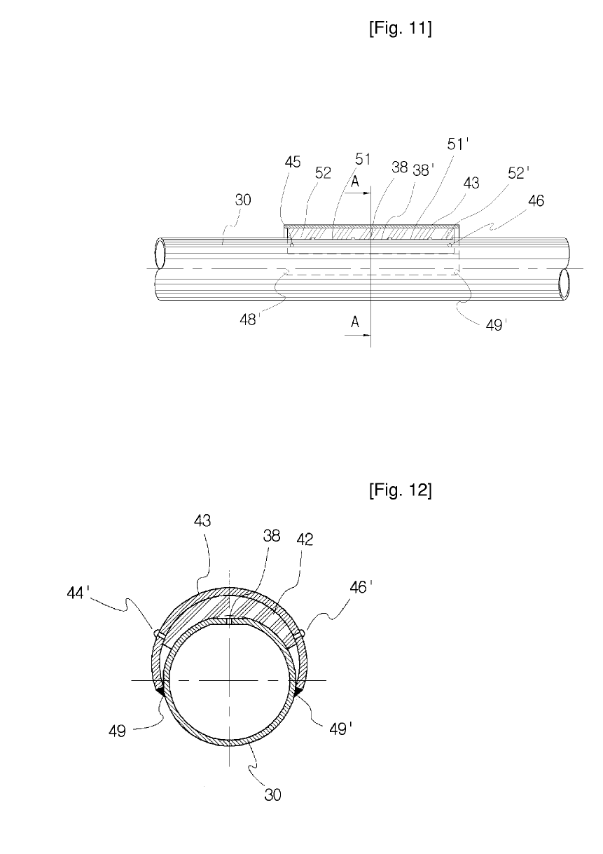

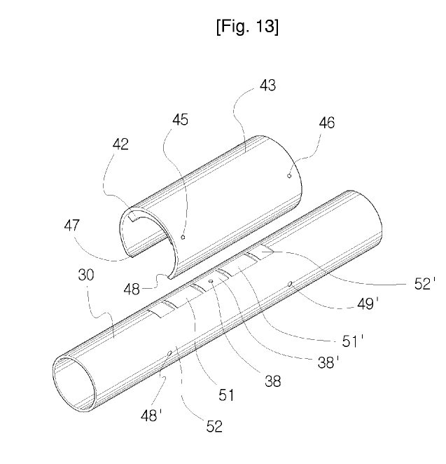

FIG. 11 is a cross sectional view showing a dripping hose buried in a heavy culture medium layer or under ground, wherein various water possessing spaces are soaked around a hole, and wherein a dripping plate cover is mounted to the dripping hose so that a dripping plate made of silicon or soft rubber is inserted therein to cover the water possessing space, FIG. 12 is a sectional view showing the dripping hose of FIG. 11, taken along the line A-A, and FIG. 13 is an exploded perspective view showing a dripping hose to which the dripping plate cover of FIG. 11 is mounted.

As shown in FIGS. 11 to 13, water possessing spaces 38′, 51, 51′, 52, 52′ various shapes and holes 38 through which water or nutrition liquid is soaked are formed in every predetermined region of the high pressure tube 30. A dripping plate 42 having fixed protrusions 44′, 46′, . . . fixed to at least four dripping plate fixing grooves 45, 46, . . . is fixed in a dripping plate cover 43 so as to cover the water possessing spaces 38′, 51, 51′, 52, 52′ and the holes 38. In addition, this dripping plate cover 43 is made of plastic or steel, and a dripping plate 42 with an arch or other shape is detachably attached to the dripping plate cover 43 so as to prevent a water flowing dripping portion of the holes 38 or the water possessing spaces 38′, 51, 51′, 52, 52′ from being completely clogged due to pressure of the culture medium layer or soil. Dripping cover fixing units 47, 48, . . . are firmly fixed to fixing grooves 48′, 49′, . . . of the high pressure tube 30. For example, in case the dripping plate cover fixing units 47, 48, . . . are made of plastic, they may be adhered to the cover fixing grooves 48′, 49′, . . . of the high pressure tube 30 or be integrally fixed thereto by applying heat thereto by a heater. Since the dripping plate cover 43 is formed as mentioned above, gaps of the water possessing spaces 38′, 51, 51′, 52, 52′ may be softly opened regardless of load of soil or height of topography when water is supplied, so water may be constantly discharged.

### INDUSTRIAL APPLICABILITY

In the present invention as mentioned above, water is flowed out through both ends or one end of the rubber outer tube 7a, 11a doubly inserted into each blade scar of the dripping nozzle 11 or the dripping hose 7 only when the water is dripped, and the rubber outer tube 7a, 11a prevents the blade scar from being exposed directly to the culture medium layer, so the water is not contacted with external oxygen, thereby preventing mycelia from being coated in the blade scar holes and thus preventing the water hole from being clogged.

It is very meaningful in the point that a mushroom cultivating farmhouse may easily conduct a watering work, which was laborious in the prior art, without excess so that water is slowly dripped onto the culture medium layer 5 to keep the best cultivating environment.

In addition, various alien substances contained in the culture medium layer or the supplied water are not introduced through the blade scars 6 formed in the soft rubber with good flexibility, and water and insect control liquid may be supplied from water tank and ejected without any clogging by means of water pressure.

As mentioned above, the present invention gives internal irrigation only in the culture medium layer, which prevents factors of brown spot by which mushroom roots are rotten due to the excess of water or mushroom mustard dies or gets brown due to the lack of oxygen respiration, thereby improving productivity. The present invention may be applied not only to mushroom cultivating farmhouses but also vegetable or flower farmhouses by those having ordinary skill in the art so that the drip irrigation system mentioned above may be used therein.

According to the present invention, water or nutrition liquid is supplied due to expansion or contraction of the dripping plate or the dripping ring caused by water pres sure. Thus, water is dripped only when a water pressure of the dripping hose is over a predetermined level, and when the water pressure of dripped water increases, a great amount of water is supplied to discharge impurities such as dregs, thereby giving a cleaning function for the dripping hose. In addition, a dripping amount may be freely controlled in a dripping portion where water flows according to the shape of the dripping ring, and the dripping ring may be attached only to the hole when necessary, so it may be effectively managed in a lawn of a golf course, a grass in a park and so on.

1. A drip irrigation system used in a mushroom cultivating equipment in which a high pressure tube 3 of a predetermined length is inserted into a culture medium layer 5 of a mushroom cultivating plate 4 placed on a frame 9 so that water in a water tank 2 having a ball tap 1 is continuously supplied, wherein a dripping hose 7 made of soft rubber with a predetermined length and having several blade scars 6 with a length of 1 to 2 mm formed only on a middle outer circumference thereof is provided in every predetermined region of the high pressure tube 3 so that an outer tube 7a made of soft rubber is inserted into the dripping hose 7 to cover only the blade scars and both ends of the dripping hose 7 are inserted into the high pressure tube 3 and fixed by a tie band 8, wherein, wherein an outer tube 11a made of soft rubber is inserted into a dripping nozzle 11 made of soft rubber with one sharp end and having several blade scars 6 with a length of 1 to 2 mm formed only on a middle outer circumference thereof at the outermost end of the high pressure tube 3 so as to cover the blade scars so that the outer tube 11a is fixed to the high pressure tube 3 by means of the tie band 8 integrally with the dripping nozzle 11.

2. The drip irrigation system according to claim 1,
wherein the dripping nozzle 11 made of soft rubber is fixed to the high pressure tube 3 by the tie band 8 by inserting the outer tube 11a made of soft rubber thereto so that the dripping nozzle 11 is inserted into the culture medium 5 of a mushroom cultivating port 13.

3. The drip irrigation system according to claim 1,
wherein a step is formed in every predetermined region of the high pressure tube 3, at least one hole 15 is formed at the center of the stepped dripping hose 7, and the outer tube 11a made of soft rubber has a dripping ring 32 having good flexibility so as to cover the step.

4. The drip irrigation system according to claim 3, wherein the dripping hose 7 includes:
a high pressure tube 30 having water possessing spaces 38′, 51, 51′, 52, 52′ provided at regular intervals with various shapes, and holes 38 formed therein so that water or nutrition liquid is soaked therein;
a dripping plate 42 having fixed protrusions 44′, 46′, . . . fixed to dripping plate fixing grooves 45, 46, . . . so as to cover the water possessing spaces 38′, 51, 51′, 52, 52′ and the holes 38; and
a dripping plate cover 43 to which a dripping plate with an arch or other shape is detachably attached and including dripping cover fixing units 47, 48, fixed to cover fixing grooves 48′, 49′, . . . of the high pressure tube 30 so as to prevent a water flowing dripping portion of the holes 38 or the water possessing spaces 38′, 51, 51′, 52, 52′ of the dripping plate 42 from being completely clogged due to pressure of the culture medium layer or soil.

5. The drip irrigation system according to claim 4,
wherein around the hole 38 has a circumference concavely engraved so as to ensure water possessing spaces.
